(19) United States
(12) Patent Application Publication
(10) Pub. No.: US 2020/0042014 A1
(43) Pub. Date: Feb. 6, 2020

(54) COORDINATION OF PATHS OF A PLURALITY OF MOVABLE MACHINES

(71) Applicant: KUKA Deutschland GmbH, Augsburg (DE)

(72) Inventors: Moritz Martens, Augsburg (DE); Tabea Grams, Augsburg (DE); Stefan Loibl, Adelsries (DE); Ingo Kresse, Augsburg (DE)

(21) Appl. No.: 16/321,806

(22) PCT Filed: Jul. 19, 2017
(86) PCT No.: PCT/EP2017/000881

§ 371 Date: Jan. 29, 2019

(30) Foreign Application Priority Data
Jul. 29, 2016 (DE) 10 2016 009 255.6

(51) Int. Cl. G05D 1/02; G08G 1/16

(52) U.S. Cl. CPC G05D 1/0289; G05D 2201/0216; G08G 1/166

(57) ABSTRACT

A method for at least partially automated coordination of a path arrangement of a machine arrangement, having a path of at least one first movable machine and an additional path of at least one second movable machine. The method includes determining at least one waiting dependency between a path point of a path of a first machine in the machine arrangement and a path point of the additional path in order to avoid a collision between the first and second machines, provided that a quality criterion for leaving the paths while complying with this waiting dependency is not worse than complying with an alternative inverse waiting dependency between a path point of the path of the first machine and a path point of the additional path in order to avoid the same collision.

### CROSS-REFERENCE TO RELATED APPLICATIONS

This application is a national phase application under 35 U.S.C. § 371 of International Patent Application No. PCT/EP2017/000881, filed Jul. 19, 2017 (pending), which claims the benefit of priority to German Patent Application No. DE 10 2016 009 255.6, filed Jul. 29, 2016, the disclosures of which are incorporated by reference herein in their entirety.

### TECHNICAL FIELD

The present invention relates to a method and system for at least partially automated coordination of a path arrangement of a machine arrangement, having a path of at least one first movable machine in the machine arrangement and an additional path of at least one second movable machine, and relates to a computer program product for implementing the method.

### BACKGROUND

Collisions are to be avoided in particular for a fleet of automated guided vehicles (AGV) that travel prespecified paths.

To this end, according to internal practice it is known to instruct lower priority vehicles to wait for a higher priority potential collision partner to reach a certain path point before the lower priority vehicles themselves are permitted to leave their path point.

However, this may lead to unnecessarily long wait times.

### SUMMARY

The object of the present invention is to improve joint traveling of paths by two or more movable machines.

This object is attained using a method as disclosed herein. A system and computer program product for executing the method are also described.

According to one embodiment of the present invention, a machine arrangement has one or a plurality of movable machines that may here be called first (movable) machines and for each of which a path is determined, in particular is determined in advance and/or specified.

In addition, provided in one embodiment, in particular successively, in particular provided as an addition or subsequently, is/are one or a plurality of movable machine(s), here called second (movable) machine(s), for (each of) which a path is also determined, in particular determined in advance and/or specified.

In particular, in one embodiment, the path arrangement may initially be formed by a first path of a first movable machine in an initial machine arrangement that comprises said first movable machine, which path or machine is coordinated in a manner described herein with an additional path of a second movable machine. This first and this second movable machine may then themselves form a (new) machine arrangement and these paths may form a (new) path arrangement of this (new) machine arrangement, which itself is coordinated with an additional path of another second movable machine, and so on. In this way, in one embodiment three or more movable machines and their paths may be coordinated successively and may jointly travel with no collision and no indefinite waiting dependency.

Coordination of AGVs represents a particularly advantageous application of the invention. Accordingly, in one embodiment, each path may have, in particular may be, a lane of an automated guided vehicle. The present invention is therefore explained in the following in particular with reference to these particularly advantageous applications, but is not limited thereto. Thus in particular, coordination of movable robot arms represents another advantageous application of the present invention. Accordingly, in one embodiment each path may have, in particular may be, a trajectory of a movable robot arm.

For a more compact representation, the path or paths of the first machine(s) is/are called the path arrangement of the machine arrangement of the first machine(s). In one embodiment, it or the machine arrangement is prioritized by default or standard with respect to the additional path or the second machine. In other words, in one embodiment, a newly added (second) machine or its path is or has a lower priority by default or standard than the already provided, in particular coordinated, (first) machine(s) or path(s) and, in order to avoid a collision with a first machine must, by default or standard, always wait for the latter. This attains an advantageous basic coordination.

According to one embodiment of the present invention, one method for complete or partially automated coordination of the path arrangement of the machine arrangement and the additional path or the additional paths of the second movable machine(s) in each case has the step of: defining at least one waiting dependency between a path point of a path of a first machine in the machine arrangement and a path point of the additional path in order to avoid (in each case) a collision between the second machine and this first machine, provided that a quality criterion, in particular a prognosticated quality criterion, for jointly traveling, in particular with no indefinite waiting dependency, the path arrangement and the additional path while complying with this waiting dependency is not worse, in particular is (even) better than when complying with an alternative inverse waiting dependency between a, in particular different or the same, path point of the path of the first machine and a, in particular different or the same, path point of the additional path in order to avoid the same collision.

In one embodiment the quality criterion or its value(s) may be unidimensional or multidimensional and/or may depend on a traveling time for one or a plurality of the machines for jointly traveling, in particular with no indefinite waiting dependency, the path arrangement and the additional path, in particular may depend on or indicate these in particular weighted and/or hierarchically linked traveling time(s).

In one embodiment, a quality criterion (value) is worse if the traveling time for one or a plurality of machines, in particular higher priority machines, is longer, and/or better, if the traveling time of at least one machine is shorter, in particular only if the traveling time for one or a plurality of other machines, in particular of all higher priority other machines, is not longer.

In one embodiment, a or the quality criterion (value) is (already) worse if the traveling time of at least one higher priority machine, in particular one machine in the machine arrangement, is longer, even if the traveling time of at least one lower priority machine, in particular the second machine, is shorter, and/or a quality criterion (value) is (only) better if the traveling times of all machines taken into consideration in the quality criterion, in particular all machines in the machine arrangement, in particular all machines to be coordinated, is not longer and at least one of these traveling times is shorter. In addition or alternatively, in one embodiment a shorter traveling time of at least one higher priority machine may compensate a longer traveling time of at least one lower priority machine or effect a better quality criterion (value).

For example, if three machines, while complying with a waiting dependency, have a traveling time T1,1 for the highest priority machine, a traveling time T2,1 for the medium priority machine, and a traveling time T3,1 for the lowest priority machine, and, while complying with an alternative inverse waiting dependency, have a traveling time T1,2 for the highest priority machine, a traveling time T2,2 for the medium priority machine, and a traveling time T3,2 for the lowest priority machine, in one embodiment the value of a quality criterion for jointly traveling while complying with the waiting dependency can be better than the value of the quality criterion while complying with the alternative inverse waiting dependency if: (T1,1 T1 and T2,1 T2,2 and T3,1<T3,2) or (T1,1 T1 and T2,1<T2,2 and T3,1 T3,2) or (T1,1<T1 and T2,1 T2,2 and T3,1 T3,2), that is, only if at least one of the traveling times is reduced, without at least one other of the traveling times being extended. Likewise, in one embodiment the value of the quality criterion for jointly traveling while complying with the one waiting dependency may be better than the value of the quality criterion while complying with the alternative inverse waiting dependency if: (T1,1 T1 and T2,1 T2,2 and T3,1<T3,2) or (T1,1 T1 and T2,1<T2,2) or (T1,1<T1), that is, always when the traveling time of a higher priority machine is reduced. This represents, so to say, a prioritized pareto optimality. Additionally or alternatively, other, in particular weighted and/or hierarchized links of traveling times, for example pareto optimality, are of course also possible, in particular among all machines or among machines having the same priority, a total or maximum traveling time, or the like.

Accordingly, in one embodiment the method has the step: defining at least one waiting dependency between a path point of a path of a first machine in the machine arrangement and a path point of the additional path in order to avoid (in each case) a collision between the second machine and this first machine, provided that at least one traveling time, in particular at least one prognosticated and/or higher priority traveling time, for jointly traveling, in particular with no indefinite waiting dependency, the path arrangement and the additional path, while complying with this waiting dependency, is not longer, in particular is (even) shorter, than when complying with an alternative inverse waiting dependency between a path point, in particular a different or the same path point, of the path of the first machine and a path point, in particular a different or the same path point, of the additional path in order to avoid the same collision.

According to one embodiment of the present invention, a system for complete or partially automated coordination of the path arrangement of the machine arrangement and the additional path or the additional paths of the second movable machine(s) is designed for implementing a method described here, in particular using technical hardware and/or software, in particular programmatically, and/or has: means for defining at least one waiting dependency between a path point of a path of a first machine in the machine arrangement and a path point of the additional path in order to avoid (in each case) a collision between the second machine and this first machine, provided that a quality criterion, in particular a prognosticated quality criterion, for jointly traveling, in particular with no indefinite waiting dependency, in particular at least one traveling time, in particular at least one prognosticated traveling time, for jointly traveling, in particular with no indefinite waiting dependency, the path arrangement and the additional path while complying with this waiting dependency is not worse or longer, in particular is (even) better or shorter, than when complying with an alternative inverse waiting dependency between a, in particular different or the same, path point of the path of the first machine and a, in particular different or the same, path point of the additional path in order to avoid the same collision.

In this way, in one embodiment a quality criterion (value) for jointly traveling, in particular with no indefinite waiting dependency, the path arrangement and the additional path, while complying with this waiting dependency and thus avoiding this collision is advantageously improved, in particular at least one traveling time for jointly traveling, in particular with no indefinite waiting dependency, the path arrangement and the additional path arrangement while complying with this waiting dependency and thus avoiding this collision are advantageously reduced.

In one embodiment, a path may have a plurality of path points and transfers, in particular transfer times, between the path points, in particular may be prespecified thereby, in particular in advance or prior to the joint traveling and/or during the joint traveling.

In one embodiment, a waiting dependency between one path point of a path of a first machine in the machine arrangement and one path point of the additional path in order to avoid a collision between the second machine and this first machine permits leaving a path point of the one of these two paths only after a path point of the other of these two paths has been reached in order to avoid a collision, and an alternative inverse waiting dependency permits leaving a path point of the other of these two paths only after a path point of the one of these two paths has been reached in order to avoid this collision.

In particular, in one embodiment a wait dependency in the context of the present invention in particular permits leaving a path point of the additional path (by the first machine) only after a path point of a path of a first machine in the machine arrangement has been reached (by the first machine), and an alternative inverse waiting dependency permits leaving a path point of the path of this first machine (by it) only after a path point of the additional path has been reached (by the second machine). Likewise, in one embodiment, a waiting dependency in the context of the present invention permits leaving a path point of a path of a first machine in the machine arrangement (by the first machine) only after a path point of the additional path has been reached (by the second machine) and an alternative inverse waiting dependency permits leaving a path point of the additional path (by the second machine) only after a path point of the path of the first machine has been reached (by the first machine).

Jointly traveling the path arrangement and the additional path shall be understood here to mean coordinated traveling, in particular at least partially simultaneous and/or successive traveling, of the paths by the machines.

With no indefinite waiting dependency or blockade-free traveling shall be understood here to mean in particular traveling while complying with one or a plurality of waiting dependencies in which all paths are traveled in a finite period or no cycle or so-called “deadlock” or blockade occurs in which each machine waits for another of the machines and thus no machine can (further) travel its path, comparable for example to a fully occupied intersection of two identically prioritized paths with the waiting dependency “right before left” and four vehicles.

In one embodiment, the collision (that is to be avoided by the waiting dependency) is determined in advance as a possible collision when there is joint traveling of the path arrangement and of the additional path without complying with this (at least one defined) waiting dependency. Correspondingly, in one embodiment the system has means for determining the collision in advance as a possible collision when there is joint traveling of the path arrangement and of the additional path without complying with the at least one defined waiting dependency. In this way collisions may be advantageously avoided in one embodiment.

In one refinement, it is determined, in particular successively, for each (planned) step or transfer from one path point to a subsequent path point of the additional path whether there is a drop below a prespecified distance to some path point or transfer of some path of the path arrangement, in particular whether the path point or transfer of some path of the path arrangement is reached or intersected. In such a case, a possible collision is determined. In one embodiment, possible collisions may be advantageously avoided in this manner.

In one embodiment, a waiting dependency is determined between a path point of the path of the first machine and a path point of the additional path in order to avoid a collision between one path point of the one path after, in particular immediately after, the possible collision and one path point of the other path prior to, in particular immediately prior to, the possible collision. Accordingly, in one embodiment the system has means for determining a waiting dependency between one path point of the path of the first machine and one path point of the additional path in order to avoid a collision between one path point of the one path after, in particular immediately after, the possible collision and one path point of the other path prior to, in particular immediately prior to, the collision. In this way waiting dependency may advantageously be determined in one embodiment.

In one refinement, for a (planned) step or transfer from one (initial or starting) path point to a subsequent path point of a path, in each case a conflict zone of the other path is determined, which conflict zone has a first and a last path point and one or a plurality of intermediate path points, wherein the machine may execute the (planned) step or transfer if the other machine is disposed on the first or last path point, but may not execute the planned step or transfer for as long as the other machine is disposed on an intermediate path point or a transfer from or to the latter, in order to (reliably) avoid a collision. Then the waiting dependency between this last path point and the (initial or starting) path point of the (planned) step or transfer may be determined. In this way waiting dependencies may advantageously be determined in one embodiment.

In one embodiment, the method comprises the steps: for one or a plurality of possible collisions of the second machine with the or with a or with a plurality of the first machine(s) in the machine arrangement, determining a, in particular prognosticated, first value of the quality criterion for jointly traveling, in particular with no indefinite waiting dependency, in particular of at least one, in particular prognosticated, first traveling time for jointly traveling, in particular with no definite waiting dependency, the path arrangement and the additional path, while complying with a first waiting dependency between one path point of the path of this first machine and one path point of the additional path in order to avoid this collision, in particular determining a waiting dependency of the second machine relative to the first machine; determining a, in particular prognosticated, second value of the quality criterion for jointly traveling, in particular with no definite waiting dependency, in particular of at least one, in particular prognosticated, second traveling time for jointly traveling, in particular with no definite waiting dependency, the path arrangement and the additional path, while complying with an alternative inverse second waiting dependency between a path point of the path of this first machine and a path point of the additional path in order to avoid this collision, in particular determining a waiting dependency of the first machine relative to the second machine; and selecting the first or second waiting dependency as (the) defined waiting dependency in order to avoid this collision based on the first and second quality criterion value, in particular the at least one first traveling time and second traveling time, in particular the first waiting dependency, if the first quality criterion is not worse, in particular is (actually) better than the second quality criterion, and/or the second waiting dependency, if the second quality criterion value is not worse, in particular is (actually) better, than the first quality criterion value, in particular if the first traveling time(s) is/are not greater than, in particular (at least one) is (actually) less than the (corresponding) second traveling time(s), in particular without extending a higher priority and/or the second waiting dependency, if the second traveling time(s) are not greater than, in particular (at least one) is (actually) less than the (corresponding) first traveling time(s), and in particular without extending a higher priority, in particular (only), provided no indefinite waiting dependent leaving of the path arrangement and the additional path is possible while complying with this waiting dependency.

Accordingly, in one embodiment the system has means for determining one or a plurality of possible collisions between the second machine and the or a or a plurality of the first machine(s) in the machine arrangement (in each case) of one, in particular prognosticated, first value of the quality criterion for jointly traveling, in particular with no indefinite waiting dependency, in particular at least one, in particular prognosticated, first traveling time to jointly traveling, in particular with no indefinite waiting dependency, the path arrangement and the additional path while complying with a first waiting dependency between a path point of the path of this first machine and a path point of the additional path in order to avoid this collision, in particular for determining a waiting dependency of the second machine relative to the first machine, of a, in particular prognosticated, second value of the quality criterion for jointly traveling, in particular with no indefinite waiting dependency, in particular at least one, in particular prognosticated, second traveling time relative to jointly traveling, in particular with no indefinite waiting dependency, the path arrangement and the additional path, while complying with an alternative inverse second waiting dependency between a path point of the path of this first machine and a path point of the additional path in order to avoid this collision, in particular a waiting dependency of the first machine relative to the second machine; and selecting the first or second waiting dependency as (the) defined waiting dependency in order to avoid this collision based on the first and second quality criterion, in particular the at least one first and second traveling time, in particular the first waiting dependency, if the first quality criterion is not worse, in particular is (actually) better than the second quality criterion, and/or the second waiting dependency, if the second quality criterion is not worse, in particular is (actually) better, than the first quality criterion, in particular if the first traveling time(s) are not greater than, in particular (at least one) is/are (actually) less than the (corresponding) second leaving time(s), without extending a higher priority and/or the second waiting dependency, if the second traveling time(s) is/are not greater than, in particular (at least one) is/are (actually) less than the (corresponding) first traveling time(s), in particular without extending a higher priority, in particular (only) provided no indefinite waiting dependent travel of the path arrangement and the additional path is possible while complying with this waiting dependency.

In other words, in one embodiment, a waiting dependency, due to which the second machine must wait for the first machine, is tentatively replaced, tentatively in a reversed manner or using an alternative inverse waiting dependency, due to which the first machine must wait for the second machine, in order to avoid the same (possible) collision, and then that waiting dependency is defined in which the better quality criterion results for jointly traveling, in particular with no indefinite waiting dependency, in particular the shorter traveling time for at least one of the machines, in particular without extending the traveling time of at least one higher priority machine, for jointly traveling, with no indefinite waiting dependency, the path arrangement and the additional path.

In this way, in one embodiment, a quality criterion (value) for jointly traveling, in particular with no indefinite waiting dependency, the path arrangement and the additional path, while complying with this waiting dependency and thus avoiding this collision is advantageously improved, in particular at least one traveling time for jointly traveling, with no indefinite waiting dependency, the path arrangement and the additional path, while complying with this waiting dependency and thus avoiding this collision, may be advantageously reduced.

In particular using such reversal of a waiting dependency, an indefinite waiting dependency or a so-called cycle or “deadlock,” in which each machine waits for one of the other machines, can result in an undesired manner.

Therefore, in one embodiment, the method has the steps: for at least one waiting dependency between one path point of the path of a first machine in the machine arrangement and one path point of the additional path, (in each case) replacing at least one, in particular inverse, additional waiting dependency, in particular an additional waiting dependency between one path point of the path of the first machine and one path point of the additional path, with a different waiting dependency that is alternative and inverse to this additional waiting dependency, if the one waiting dependency causes an indefinite waiting dependency, in particular with an alternative inverse other waiting dependency between one path point of the path of the first machine and one path point of the additional path. Accordingly, in one embodiment the system has means for replacing, for at least one waiting dependency between one path point of the path of a first machine in the machine arrangement and one path point of the additional path, another waiting dependency, in particular an inverse waiting dependency, in particular between one path point of the path of the first machine and one path point of the additional path, with a different waiting dependency that is alternative and inverse to this other waiting dependency, if the one waiting dependency causes an indefinite waiting dependency, in particular with an alternative inverse other waiting dependency between one path point of the path of the first machine and one path point of the additional path.

In particular, in one embodiment an indefinite waiting dependency or a so-called cycle or “deadlock” that would result due to a determined or introduced waiting dependency, in particular a reversal of a waiting dependency to an alternative inverse waiting dependency, is avoided or resolved in that at least one additional waiting dependency that also causes this indefinite waiting dependency, or includes this cycle or “deadlock,” is replaced by an alternative inverse other waiting dependency. In this way, in one embodiment, an indefinite waiting dependency or a so-called cycle or “deadlock” may be avoided or resolved. In one embodiment, other tentative waiting dependencies that cause an indefinite waiting dependency or a cycle are successively replaced by alternative inverse other waiting dependencies until the corresponding indefinite waiting dependency is resolved or the corresponding cycle has been eliminated or all waiting dependencies that cause these have been worked through or replaced by alternative inverse other waiting dependencies.

Provided (it has been determined that) even by replacing one or a plurality, in particular all, of other waiting dependencies an indefinite waiting dependency or a so-called cycle or “deadlock” that would result due to a determined or introduced waiting dependency, in particular a reversal of a waiting dependency to an alternative inverse waiting dependency, cannot be avoided or resolved, in one embodiment this one waiting dependency is not introduced, in particular this reversal of a waiting dependency to an alternative inverse waiting dependency is discarded, or the non-reversed waiting dependency is retained or determined as waiting dependency. In one embodiment, one or a plurality of the non-introduced or non-converted or non-discarded waiting dependencies are blocked so that they are no longer tried out during (further) coordination or in the future.

In one embodiment, the method is partially or completely executed prior to and/or during joint traveling of the path arrangement and the additional path or is designed for this. Accordingly, in one embodiment, the system partially or completely executed the method prior to and/or during joint traveling of the path arrangement and the additional path or is designed for this. Thus, in one embodiment, in particular joint traveling of the prespecified path arrangement may be coordinated, in particular in advance, and of the prespecified additional path may be coordinated, in particular in advance, offline and/or online, wherein in one refinement during online coordination during joint traveling, in particular parts of the path that have already been traveled are omitted and/or parts of the path that are still to be traveled are just taken into account, in particular coordinated, successively. In one embodiment, quality criterion values, in particular traveling times, may be prognosticated, or may be, based on prespecified or previously determined transfer times between path points of the paths.

In one embodiment, the path arrangement and the additional path are prespecified in the form of a directed acyclic or cycle-free graph, path points in the form of nodes (of the graph) and waiting dependencies in the form of directed transverse lines between nodes of the path arrangement and the additional path. In this way, in one embodiment coordination may advantageously be realized by computer.

In one embodiment, the coordination comprises in particular guiding, in particular conducting, and/or controlling the machines.

Means in the context of the present invention may be embodied in technical hardware and/or software, in particular may have a, in particular digital, processing unit, in particular a microprocessor unit (CPU) with data or signal connection to a memory and/or bus system, and or may have one or a plurality of programs or program modules. The CPU may be embodied to process commands that are implemented as a program stored in a memory system, detect input signals from a data bus, and/or emit output signals to a data bus. A memory system may have one or a plurality of, especially different, storage media, in particular optical, magnetic, solid state, and/or other non-volatile media. The program may be created such that it is able to embody or execute the methods described here so that the CPU can execute the steps of such methods and thus in particular can coordinate the machines, in particular guide and/or control the machines.

In one embodiment, one or a plurality of steps, in particular all of the steps, of the method are executed in a completely or partially automated manner, in particular using the control or its means.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 depicts a path arrangement of a first machine and an additional path, to be coordinated therewith, of a second machine, according to one embodiment of the present invention;

FIG. 2 depicts aligned graphs for coordinating the paths according to one embodiment of the present invention; and,

FIG. 3 depicts a method for coordinating the paths according to one embodiment of the present invention.

### DETAILED DESCRIPTION

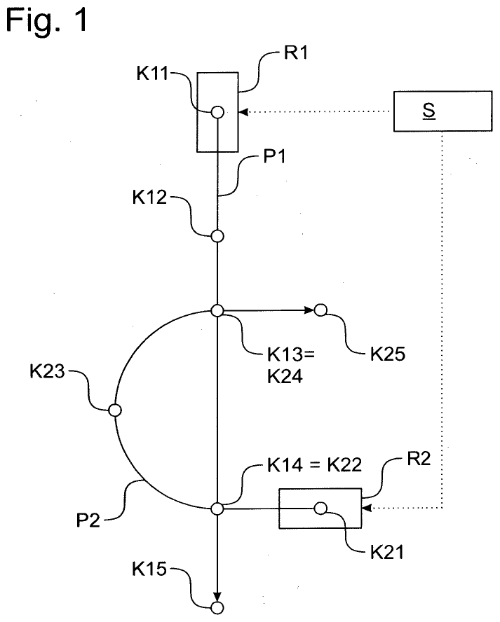

FIG. 1 depicts a machine arrangement which, for better understanding, comprises only a first movable machine in the form of an AGV R1, a second movable machine in the form of another AGV R2, and a system S for automated coordination of a path arrangement of the machine arrangement, which correspondingly comprises a prespecified path P1 of the AGV R1 and an additional path P2 of the AGV R2. The system S guides the AGVs R1, R2 and for this purpose is connected to them by signal, as indicated in FIG. 1 with the dotted line.

The path P1 comprises, as an example, five path points K11-K15 and transfers with prespecified or previously determined transfer times between them, the path P2, as an example, also comprises five path points K21-K25 and transfers between them with prespecified or previously determined transfer times.

It may be seen that the AGVs R1, R2, when jointly traveling the paths P1, P2, could collide at the path points K14=K22 and K13=K24. For better understanding, this is selected such that a collision could just as well occur due to an intersection of two transfers or due to the path points or transfers being too close to one another.

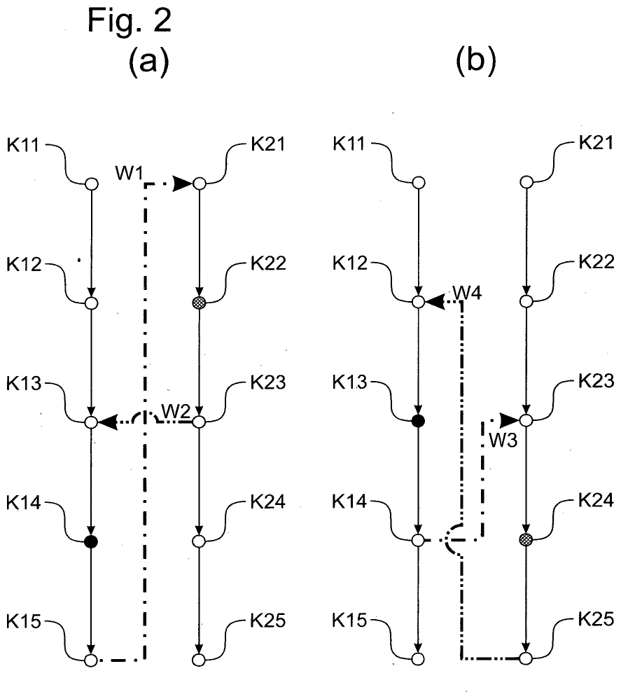

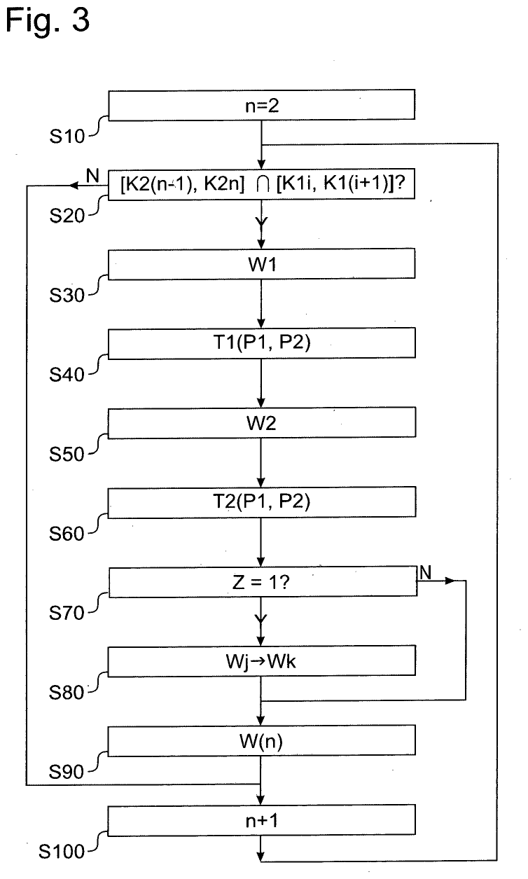

According to one embodiment of the invention, to avoid such a collision, the system S executes a method, explained in greater detail in the following with respect to FIGS. 2, 3, for coordinating the paths P1, P2.

As is depicted in FIG. 2 under (a) and (b), the paths P1, P2 are provided in the form of directed acyclic graphs, the path points in the form of nodes K11-K25, and subsequently explained waiting dependencies W1-W4 in the form of directed transverse lines between nodes.

Since the additional path P2 is added subsequent to the already coordinated path arrangement P1, in a step S20 (see FIG. 3) the system checks whether a collision with the AGV R1 is possible during the first (planned) step or transfer of the AGV R2 from path point K21 to path point K22. If this is not the case (S20: “N”), the system continues with the next (planned) step or transfer without determining a waiting dependency in that the system in a step 100 increments a counter initialized in step S10 and then repeats step S20 for the (in each case) next (planned) step or transfer.

As may be seen in FIG. 1, however, there may already be a collision with the AGV R1 during the first (planned) step or transfer of the AGV R2 from path point K21 to path point K22.

Therefore, in the graph in FIG. 2, as shown under (a), for this (planned) step or transfer a conflict zone of the path P1 is determined, which conflict zone comprises the possible collision point K14 as the sole intermediate point and comprises the immediately preceding collision-free path point K13 as the first path point and comprises the immediately following collision-free path point K15 as the last path point.

Then, in a step S30, a first waiting dependency W1 is determined for avoiding this collision between this last path point K15 immediately following the possible collision at K14 and the starting point K21 immediately prior to the possible collision at K14 of the just examined first (planned) step or transfer K21→K22, which waiting dependency permits leaving the path point K21 of the additional path P2 only after the path point K15 of the other path P1 has been reached and in FIG. 2 is added under (a) as the directed dot-dash transverse line in the graph.

In a step S40 a first traveling time T1 for jointly traveling the paths P1, P2 while complying with this first waiting dependency is then determined based on the prespecified transfer times or the transfer times determined in advance.

In a step S50 an alternative inverse second waiting dependency W2 alternative to this first waiting dependency W1 for avoiding the same collision at K14=K22 between the path point K23 immediately following the possible collision K22 and the path point K13 immediately prior to the possible collision at K14 is determined in an analogous manner and conversely permits leaving the path point K13 of the path P1 only after the path point K23 of the additional path P2 has been reached and is added in FIG. 2 under (a) as the directed dot-dot-dash transverse line in the graph.

In a step S60, a second traveling time T2 for jointly traveling the pats P1, P2, while complying with the alternative inverse second waiting dependency W2, is then determined based on the prespecified transfer times or the transfer times determined in advance.

In a step S70 there is then a check of whether using (reversal of the first waiting dependency W1 to) this second waiting dependency W2 produces an indefinite waiting dependency or would include a cycle in the graph.

Since this is not the case here (S70: “N”), the method or system continues immediately with step S90. Otherwise (S70: “Y”), or if the second waiting dependency W2 would cause an indefinite waiting dependency, in an intermediate step S80 additionally a subsequently explained other waiting dependency W3 would be replaced by an alternative inverse other waiting dependency W4 and if necessary even other waiting dependencies would likewise be replaced by alternative inverse other waiting dependencies.

In step S90, as a default or standard, the first waiting dependency W1, due to which the added, lower priority AGV R2 has to wait for the higher priority AGV R1, is defined as waiting dependency for the (planned) step or transfer K21→K22 in order to avoid a collision at K14. However, if the second traveling time T2 is shorter than the first traveling time T2, and, possibly by reversing one or a plurality of other waiting dependencies (see step S80), joint traveling of the paths P1, P2, with no indefinite waiting dependency, is possible while complying with the alternative inverse second waiting dependency W2, the latter is defined as waiting dependency for the (planned) step or transfer K21→K22 in order to avoid a collision at K14 or the default or standard first waiting dependency W1 is replaced thereby. If no joint traveling without indefinite waiting dependency is possible, even after reversing one or a plurality of other waiting dependencies, or if the second waiting dependency W2 produces an unresolvable indefinite waiting dependency, the latter is discarded and blocked for future coordinations.

The method or system continues with the next (planned) step or transfer (K2(n−1)→K2n.

In the exemplary embodiment, as an example another possible collision is determined at the common path point K13=K24. Therefore, as is depicted in FIG. 2 under (b), in an analogous manner explained in the foregoing, in this case as well by default or standard the or a (first or other) waiting dependency W3, as a result of which the AGV R2 must wait at the path point K23 until the AGV R1 has reached the path point K14, and an alternative inverse (second or other) waiting dependency W4, is determined, which conversely only permits the AGV R1 to leave the path point K12 once the AGV R2 has reached the path point K25.

In the exemplary embodiment, as an example the waiting dependencies W2 and W3 are defined so that the AGV R2 may already travel away from K21 without the AGV R1 having to wait for the path point K23 to be reached since it has not yet reached its path point K13 (waiting dependency W2). On the other hand, the AGV R1 does not have to wait at K12 until the AGV R2 has reached its path point K25. In this way the traveling time for jointly traveling the paths P1, P2 may be minimized and at the same time it is possible to reliably prevent a collision at K14=K22 and K13=K24.

Although exemplary embodiments were explained in the foregoing description, it should be noted that a number of variations are possible.

Thus, for example, the exemplary embodiment was illustrated using a joint or overall traveling time as the quality criterion (value) without the invention being limited to this advantageous quality criterion. As already explained, the quality criterion may comprise in particular a prioritization or hierarchization of the traveling times such that the quality criterion or its value is worse if the (individual) traveling time of a higher priority machine, the AGV R1 in the exemplary embodiment, is extended, even if the (individual) traveling time of a lower priority machine, the AGV R2 in the exemplary embodiment, is reduced, or the quality criterion or its value is only better if the (individual) traveling time of a higher priority machine, the AGV R1 in the exemplary embodiment, is not extended and the (individual) traveling time of at least one machine, the AGV R1 or R2 in the exemplary embodiment, is reduced and/or if (at least) the (individual) traveling time of a higher priority machine, the AGV R1 in the exemplary embodiment, is reduced.

In addition, it should be noted that the exemplary embodiments are merely examples that shall in no way limit the scope of protection, the applications, or the structure. On the contrary, the foregoing description provides the person skilled in the art a guideline for implementing at least one exemplary embodiment, wherein various changes may be undertaken, in particular with respect to the function and arrangement of the components described, without departing from the scope of protection as it results from the claims and equivalent combinations of features.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### REFERENCE LIST

K11-K25 Path point/node
P1 Path (arrangement)
P2 Additional path
R1 Automatically guided vehicle (first movable machine)
R2 Automatically guided vehicle (second movable machine)
S System
T1, T2 First/second leaving time
W(n),
W1-W4 Waiting dependency

What is claimed is:

1-12. (canceled)

13. A method for at least partially automated coordination of a path arrangement of a machine arrangement, the path arrangement including at least one first path of at least one first movable machine in the machine arrangement and a second path of at least one second movable machine in the machine arrangement, the method comprising:
determining at least one first waiting dependency between a first path point of the first path and a first path point of the second path in order to avoid a collision between the first machine and the second machine;
wherein a first quality criterion for jointly traveling the first path and the second path while complying with the first waiting dependency is not worse than a second quality criterion for jointly traveling the first path and the second path while complying with an alternative inverse second waiting dependency between a second path point of the first path of the first machine and a second path point of the second path in order to avoid the same collision.

14. The method of claim 13, wherein the first quality criterion for jointly traveling the first path and the second path while complying with the first waiting dependency is better than the second quality criterion for jointly travelling the first and second paths while complying with the alternative inverse second waiting dependency.

15. The method of claim 13, further comprising:
determining a possible collision in advance when there is joint traveling of the first path and the second path by the first and second movable machines, respectively, without complying with the at least one first waiting dependency.

16. The method of claim 15, wherein the first waiting dependency is determined based on a first path point on one of the first or second paths that is located on that path before the possible collision, and a first path point that is located on the other of the first and second paths and which is located on that path after the possible collision.

17. The method of claim 13, further comprising, for at least one possible collision of the at least one second movable machine with the at least one first movable machine in the machine arrangement:
determining a value of the first quality criterion for jointly traveling the at least one first path and the second path while complying with the first waiting dependency between a first path point of the at least one first path and a first path point of the second path in order to avoid the collision;
determining a value of the second quality criterion for jointly traveling the at least one first path and the second path while complying with the alternative inverse second waiting dependency between a second path point of the at least one first path and a second path point of the second path in order to avoid the collision; and
selecting one of the first waiting dependency or second waiting dependency as a defined waiting dependency in order to avoid the collision based on the first and second quality criterion values.

18. The method claim 13, further comprising, for at least one waiting dependency between a path point of the first path of a first machine in the machine arrangement and one path point of the second path:
replacing the at least one waiting dependency with a different waiting dependency that is alternative and inverse to the at least one waiting dependency in response to the at least one waiting dependency causing an indefinite waiting dependency.

19. The method of claim 18, wherein at least one of:
the at least one waiting dependency is an alternative inverse waiting dependency; or
the different waiting dependency is another alternative inverse waiting dependency between a path point of the first path of the first machine and a path point of the second path.

20. The method of claim 19, wherein the at least one waiting dependency is an alternative inverse waiting dependency between one path point of the first path of the first machine and one path point of the second path.

21. The method of claim 13, wherein the first and second paths each comprise:
a plurality of path points and transfers between the path points;
wherein a waiting dependency permits leaving a path point of the second path only after a path point of the first path has been reached in order to avoid a collision; and
wherein an alternative inverse waiting dependency permits leaving a path point of the first path only after a path point of the second path has been reached in order to avoid the same collision.

22. The method of claim 21, wherein at the plurality of transfers are transfer times.

23. The method of claim 13, wherein at least one of the first or second paths comprises at least one of a lane of an automated guided vehicle or a trajectory of a movable robot arm.

24. The method of claim 13, wherein the method steps are executed at least in part prior to and/or during joint travel of the at least one first path and the second path.

25. The method of claim 13, wherein the at least one first path is prioritized by default relative to the second path.

26. The method of claim 13, wherein:
the path arrangement and the additional path are modeled by a directed acyclic graph;
path points are MODELED BY nodes; and
waiting dependencies are modeled by directed transverse lines between nodes.

27. A system for at least partially automated coordination of a path arrangement of a machine arrangement having at least a first path of at least one first movable machine in the machine arrangement and of a second path of at least one second movable machine, the system comprising:
means for defining at least one first waiting dependency between a first path point of the at least one first path and a first path point of the second path in order to avoid a collision between the second machine and the first machine;
wherein a first quality criterion for jointly traveling the first path and the second path while complying with the at least one first waiting dependency is not worse than a second quality criterion for jointly traveling the first path and the second path while complying with an alternative inverse second waiting dependency between a second path point of the first path and a second path point of the second path in order to avoid the same collision.

28. The method of claim 27, wherein the at least one first waiting dependency is better than when complying with the alternative inverse second waiting dependency.

29. A computer program product for at least partially automated coordination of a path arrangement of a machine arrangement, wherein the path arrangement includes at least one first path of at least one first movable machine in the machine arrangement and a second path of at least one second movable machine in the machine arrangement, the computer program product having a program code stored on a non-transitory, computer readable storage medium, the program code, when executed by a microprocessor, causing the microprocessor to:
determine at least one first waiting dependency between a first path point of the first path and a first path point of the second path in order to avoid a collision between the first machine and the second machine;
wherein a first quality criterion for jointly traveling the first path and the second path while complying with the first waiting dependency is not worse than a second quality criterion for jointly traveling the first path and the second path while complying with an alternative inverse second waiting dependency between a second path point of the first path of the first machine and a second path point of the second path in order to avoid the same collision.
